(19) United States
(12) Patent Application Publication
(10) Pub. No.: US 2026/0244176 A1
(43) Pub. Date: Aug. 20, 2026

(54) CONTROLLER FOR GENERATING CUSTOMIZED OUTPUT DATA

(71) Applicant: ASMedia Technology Inc., New Taipei City (TW)

(72) Inventor: Yu Yi Hsiao, New Taipei City (TW)

(73) Assignee: ASMedia Technology Inc., New Taipei City (TW)

(21) Appl. No.: 19/082,144

(22) Filed: Mar. 17, 2025

(30) Foreign Application Priority Data
Feb. 19, 2025 (TW) 114106142

(51) Int. Cl. G05B 15/02

(52) U.S. Cl. CPC G05B 15/02

(57) ABSTRACT

A controller for generating customized output data is provided. The controller includes a memory circuit, an operation circuit, and a timer. The operation circuit receives first data, obtains a plurality of time lengths of a plurality of stages corresponding to a plurality of voltage states of the first data, obtains a greatest common factor of the plurality of time lengths as a sampling time length according to the plurality of time lengths, and stores the sampling time length into the memory circuit. The timer samples second data according to the sampling time length. The operation circuit generates the customized output data according to a plurality of voltage states of the sampled second data.

### CROSS-REFERENCE TO RELATED APPLICATION

This application claims the priority benefit of Taiwan application no. 114106142, filed on Feb. 19, 2025. The entirety of the above-mentioned patent application is hereby incorporated by reference herein and made a part of this specification.

### BACKGROUND

### Technical Field

The disclosure relates to a controller, and particularly relates to a controller for generating customized output data.

### Description of Related Art

A controller may be used to control the operation of external components. The external component may be, for example, a light-emitting component. Generally, the controller may control the external component based on instructions having a preset format. However, when the external component is modified or upgraded, the format of instructions or data used by the external component is changed. The controller cannot control the external component using instructions having a preset format, nor can it interpret feedback data from the external component. Therefore, the controller must also be modified or upgraded.

Therefore, how to provide a controller that may generate customized output data according to the received data is one of the research focuses of those skilled in the art.

### SUMMARY

The disclosure provides a controller that may generate customized output data according to the received data.

In an embodiment of the disclosure, the controller includes a memory circuit, an operation circuit, and a timer. The operation circuit is coupled to the memory circuit. The operation circuit receives first data, obtains a plurality of time lengths of a plurality of stages corresponding to a plurality of voltage states of the first data, obtains a greatest common factor of the plurality of time lengths as a sampling time length according to the plurality of time lengths, and stores the sampling time length into the memory circuit. The timer is coupled to the operation circuit. The timer samples second data according to the sampling time length. The operation circuit generates customized output data according to a plurality of voltage states of the sampled second data.

Based on the foregoing, the operation circuit receives the first data and obtains the greatest common factor of the plurality of time lengths of the plurality of stages corresponding to the plurality of voltage states of the first data. The timer samples the second data according to the sampling time length. The operation circuit generates the customized output data according to the plurality of voltage states of the sampled second data. In this way, the controller may generate the customized output data according to the received data.

### BRIEF DESCRIPTION OF THE DRAWINGS

FIG. 1 is a schematic diagram of a controller according to an embodiment of the disclosure.

FIG. 2 is a schematic diagram of the generation of customized output data according to an embodiment of the disclosure.

FIG. 3 is a schematic diagram of the generation of customized output data according to an embodiment of the disclosure.

FIG. 4 is a schematic diagram of the generation of customized output data according to an embodiment of the disclosure.

FIG. 5 is a schematic diagram of a controller according to an embodiment of the disclosure.

### DESCRIPTION OF THE EMBODIMENTS

Some embodiments of the disclosure will be described in detail below with reference to the accompanying drawings. For reference numerals used in the following descriptions, same reference numerals in different accompanying drawings represent same or similar components. These embodiments are merely a part of the disclosure, and do not disclose all possible embodiments of the disclosure. More precisely, these embodiments are only examples in the scope of patent application of the disclosure.

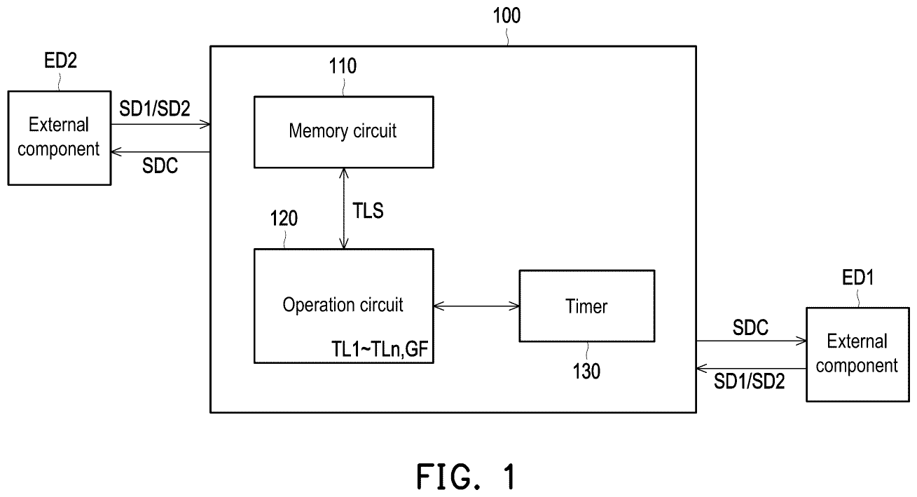

Referring to FIG. 1, FIG. 1 is a schematic diagram of a controller according to an embodiment of the disclosure. In this embodiment, a controller 100 includes a memory circuit 110, an operation circuit 120, and a timer 130. The operation circuit 120 is coupled to the memory circuit 110. The operation circuit 120 receives first data SD1, and obtains time lengths TL1 to TLn of a plurality of stages corresponding to a plurality of voltage states of the first data SD1. The operation circuit 120 obtains a greatest common factor GF of the time lengths TL1 to TLn according to the time lengths TL1 to TLn, sets the greatest common factor GF as a sampling time length TLS, and stores the sampling time length TLS into the memory circuit 110.

In this embodiment, the timer 130 is coupled to the operation circuit 120. The timer 130 samples second data SD2 according to the sampling time length TLS. The operation circuit 120 generates customized output data SDC according to a plurality of voltage states of the sampled second data SD2. For example, the operation circuit 120 may transmit the sampling time length TLS stored in the memory circuit 110 to the timer 130, so as to enable the timer 130 to sample the second data SD2 according to the sampling time length TLS.

In this embodiment, the first data SD1 may be data received by the operation circuit 120 from an external component ED1 (such as a light-emitting component, a fan, or other controlled components) and an external component ED2 (such as a control interface). The second data SD2 may be data generated internally by the controller 100 or data from at least one of the external components ED1 and ED2. Once the first data SD1 is received from the external components, the controller 100 may generate the customized output data SDC according to the second data SD2. The controller 100 may provide the customized output data SDC to the external components ED1 and ED2. The customized output data SDC may be known by the external components ED1 and ED2.

It is worth mentioning here that the operation circuit 120 receives the first data SD1 and obtains the greatest common factor GF of the time lengths TL1 to TLn of the plurality of stages corresponding to the plurality of voltage states of the first data SD1. The timer 130 samples the second data SD2 according to the sampling time length TLS stored in the memory circuit 110. The operation circuit 120 generates the customized output data SDC according to the plurality of voltage states of the sampled second data SD2. In this way, the controller 100 may generate the customized output data SDC according to the received first data SD1.

Furthermore, the customized output data SDC conforms to the data format of the external components ED1 and ED2. Therefore, when the external components ED1 and ED2 are modified or upgraded, the format of instructions or data used by the external components ED1 and ED2 may be changed. The sampling frequency or period may be changed. The sampling frequency of the current controller may not match the sampling frequency of the external components ED1 and ED2. The data output by the current controller may not be known by the external components ED1 and ED2. Thus, when the external components ED1 and ED2 are modified or upgraded, the internal logic of the current controller must be changed. In this embodiment, the controller 100 also correspondingly changes the sampling time length TLS to generate the customized output data SDC. The controller 100 may obtain the sampling time length TLS according to the received first data SD1. The control capability of the controller 100 is expanded. Therefore, when the external components ED1 and ED2 are modified or upgraded, the internal logic of the controller 100 does not need to be changed.

In this embodiment, the operation circuit 120 may be implemented by at least one of any type of computing logic circuit, decoder, and coder. The memory circuit 110 may be implemented by any type of memory component capable of storing data.

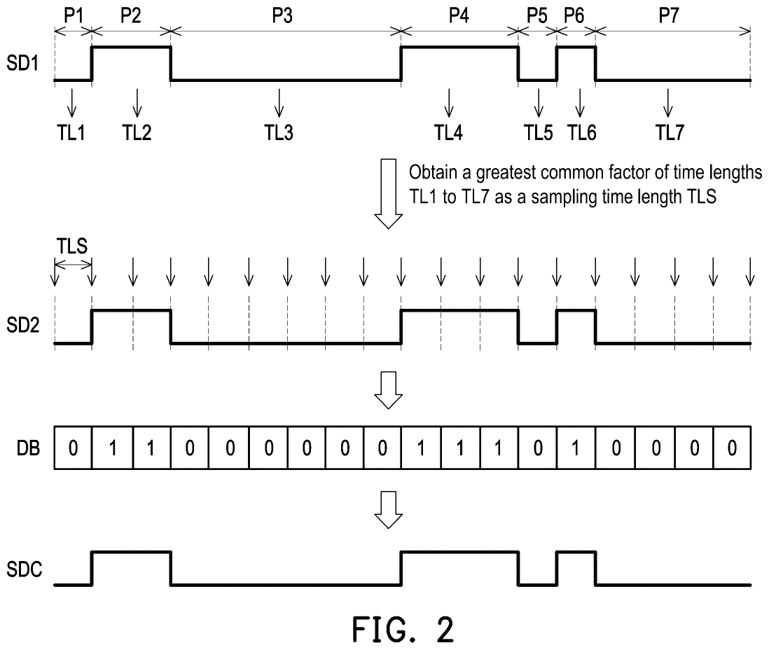

Referring to FIG. 1 and FIG. 2, FIG. 2 is a schematic diagram of the generation of customized output data according to an embodiment of the disclosure. In this embodiment, the operation circuit 120 receives the first data SD1 and obtains the time lengths TL1 to TL7 of the stages P1 to P7 corresponding to the plurality of voltage states of the first data SD1. The operation circuit 120 determines the stages P1 to P7 according to the transitions of voltage states. For example, when the voltage state changes from a low voltage state to a high voltage state, the operation circuit 120 determines the time length TL1 of the stage P1 which is in the low voltage state. Next, when the voltage state changes from the high voltage state to the low voltage state, the operation circuit 120 determines the time length TL2 of the stage P2 which is in the high voltage state, and so on.

Therefore, the operation circuit 120 obtains the time lengths TL1 to TL7, and obtains the greatest common factor GF of the time lengths TL1 to TL7 as the sampling time length TLS. For example, the time length TL1 is 5 microseconds. The time length TL2 is 10 microseconds. The time length TL3 is 30 microseconds. The time length TL4 is 15 microseconds. The time length TL5 is 5 microseconds. The time length TL6 is 5 microseconds. The time length TL7 is 20 microseconds. Thus, the greatest common factor GF is 5 microseconds. The sampling time length TLS is set to 5 microseconds.

The operation circuit 120 samples the second data SD2 based on the sampling time length TLS to obtain a bit result DB corresponding to the second data SD2. Taking stage P1 as an example, when the stage P1 of the second data SD2 is in the low voltage state, the logic value corresponding to the second data SD2 in the stage P1 is the first logic value. When the stage P1 of the second data SD2 is in the high voltage state, the logic value corresponding to the second data SD2 in the stage P1 is the second logic value.

For example, the first logic value may be the low logic value “0”. The second logic value may be the high logic value “1”. Therefore, the operation circuit 120 samples the bit values of the second data SD2 based on the sampling time length TLS as shown in the bit result DB. It should be noted that the number of bits of the bit result DB may change based on the length of the sampling time length TLS. In other words, the shorter the sampling time length TLS, the greater the number of bits in the bit result DB. The longer the sampling time length TLS, the fewer the number of bits in the bit result DB.

Next, the customized output data SDC may be generated according to the bit result DB. For example, the operation circuit 120 may generate the customized output data SDC or notify the external component ED2 to generate the customized output data SDC.

In this embodiment, the operation circuit 120 may include, for example, a computing logic circuit and a decoder (not shown). The computing logic circuit may convert the second data SD2 into the bit result DB based on the One-Hot code encoding rule and the sampling time length TLS. The decoder provides the bit result DB to the memory circuit 110.

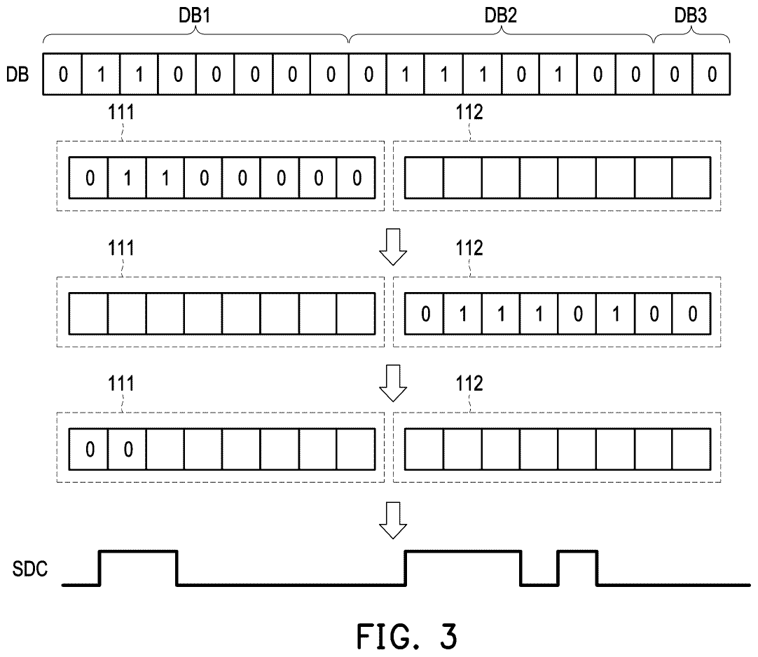

Referring to FIG. 1 and FIG. 3, FIG. 3 is a schematic diagram of the generation of customized output data according to an embodiment of the disclosure. In this embodiment, the memory circuit 110 includes memories 111 and 112. A number of bits of the memory 111 and a number of bits of the memory 112 are respectively less than a number of bits corresponding to the second data SD2. For example, based on the sampling time length TLS, the number of bits corresponding to the second data SD2 is 18 bits. The number of bits of the memories 111 and 112 is 8 bits each. Therefore, the operation circuit 120 sequentially stores a first plurality of bits DB1 corresponding to the second data SD2 into the memory 111. When a storage of the first plurality of bits DB1 is completed, the capacity of the memory 111 is full. The operation circuit 120 notifies the controller 100 to read the first plurality of bits DB1 stored in the memory 111, and stores a second plurality of bits DB2 corresponding to the second data SD2 to the memory 112.

When a storage of the second plurality of bits DB2 is completed, the capacity of the memory 112 is full. The operation circuit 120 notifies the controller 100 to read the second plurality of bits DB2 stored in the memory 112, and clear the first plurality of bits DB1 stored in the memory 111.

When the first plurality of bits DB1 stored in the memory 111 is cleared, the operation circuit 120 stores a third plurality of bits DB3 corresponding to the second data SD2 into the memory 111. Next, the operation circuit 120 notifies the controller 100 to read the third plurality of bits DB2 stored in the memory 111.

In this embodiment, the first plurality of bits DB1, the second plurality of bits DB2, and the third plurality of bits DB3 are combined to generate the customized output data SDC. In this embodiment, the controller 100 may control the decoder (not shown) in the operation circuit 120 to sequentially read the first plurality of bits DB1, the second plurality of bits DB2, and the third plurality of bits DB3, and combine the first plurality of bits DB1, the second plurality of bits DB2, and the third plurality of bits DB3 to generate the customized output data SDC. In this embodiment, the controller 100 may also notify the external component ED2 to sequentially read the first plurality of bits DB1, the second plurality of bits DB2, and the third plurality of bits DB3. The external component ED2 combines the first plurality of bits DB1, the second plurality of bits DB2, and the third plurality of bits DB3 to generate the customized output data SDC.

In some embodiments, if the number of bits corresponding to the second data SD2 is less than or equal to 16 bits, the first plurality of bits DB1 and the second plurality of bits DB2 are then combined to generate the customized output data SDC.

It is worth mentioning here that the memories 111 and 112 store the bit result DB in an alternating manner. The memories 111 and 112 are used as a ping-pong buffer. Therefore, with limited capacity (for example, 8 bits), the memories 111 and 112 may be applicable to the bit result DB of any number of bits.

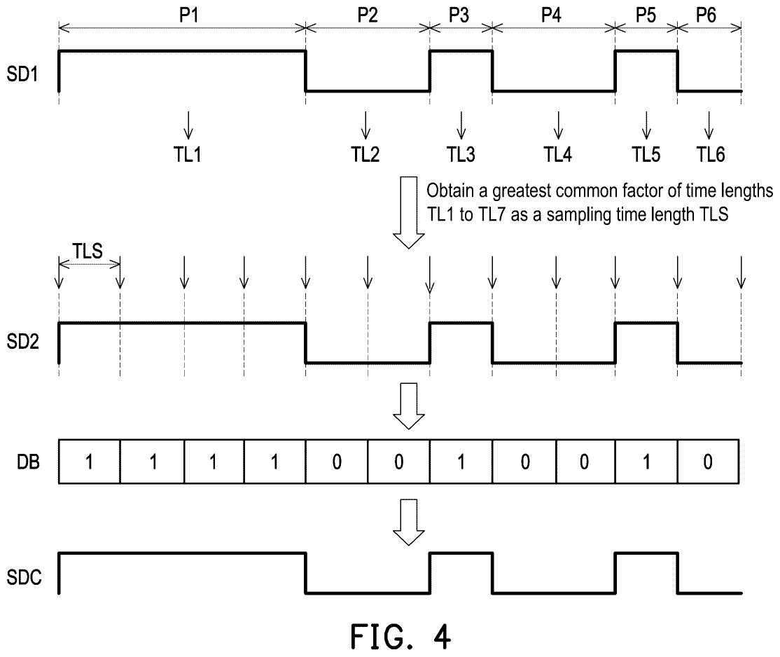

Referring to FIG. 1 and FIG. 4, FIG. 4 is a schematic diagram of the generation of customized output data according to an embodiment of the disclosure. In this embodiment, the operation circuit 120 receives the first data SD1 and obtains the time lengths TL1 to TL6 of stages P1 to P6 corresponding to the plurality of voltage states of the first data SD1. In this embodiment, the operation circuit 120 determines the stages P1 to P6 according to the transitions of voltage states. For example, the time length TL1 is 40 microseconds. The time length TL2 is 20 microseconds. The time length TL3 is 10 microseconds. The time length TL4 is 20 microseconds. The time length TL5 is 10 microseconds. The time length TL6 is 10 microseconds. Therefore, the greatest common factor GF is 10 microseconds. The sampling time length TLS is set to 10 microseconds.

The operation circuit 120 samples the second data SD2 based on the sampling time length TLS to obtain the bit result DB corresponding to the second data SD2. Next, the customized output data SDC may be generated according to the bit result DB. For example, the operation circuit 120 may generate the customized output data SDC or notify the external component ED2 to generate the customized output data SDC.

The implementation details of the operation circuit 120 have been clearly described in t embodiments of FIG. 2 and FIG. 3, and will therefore not be repeatedly described here.

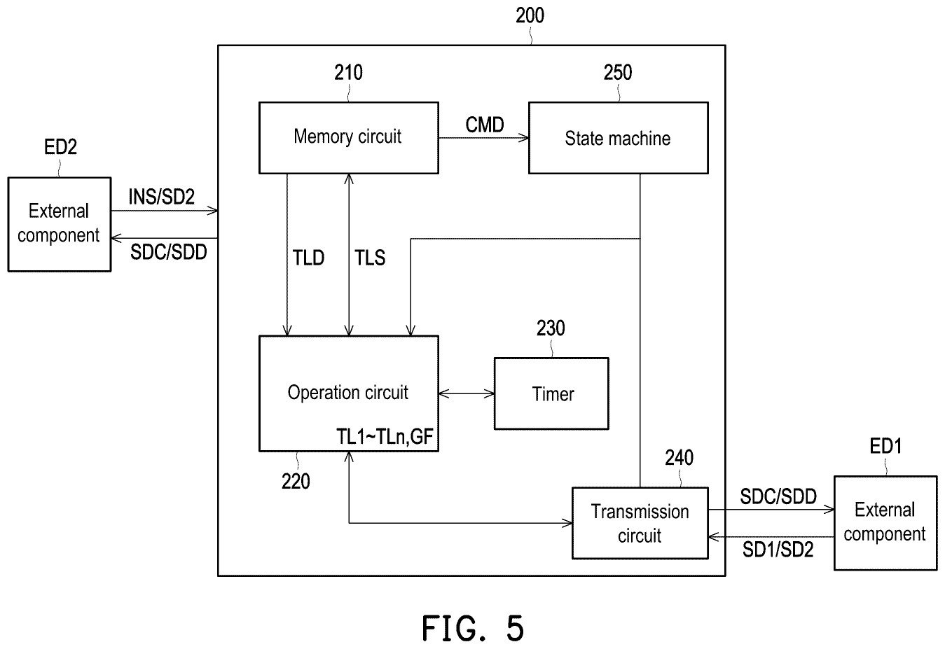

Referring to FIG. 5, FIG. 5 is a schematic diagram of a controller according to an embodiment of the disclosure. In this embodiment, a controller 200 includes a memory circuit 210, an operation circuit 220, a timer 230, a transmission circuit 240, and a state machine 250. The transmission circuit 240 is coupled to the operation circuit 220. The transmission circuit 240 receives the first data SD1. The operation circuit 220 is coupled to the memory circuit 210. The operation circuit 220 receives the first data SD1 via the transmission circuit 240 and obtains the time lengths TL1 to TLn of the plurality of stages corresponding to the plurality of voltage states of the first data SD1. The operation circuit 220 obtains the greatest common factor GF of the time lengths TL1 to TLn as the sampling time length TLS according to the time lengths TL1 to TLn, and stores the sampling time length TLS into the memory circuit 210.

In this embodiment, the state machine 250 is coupled to the operation circuit 220. The state machine 250 may control the operation circuit 220 to perform sampling operations on the first data SD1 and the second data SD2 to generate one of preset output data SDD and the customized output data SDC. The state machine 250 may also control the data receiving operation and data output operation of the transmission circuit 240.

The state machine 250 indicates the operation circuit 220 to generate one of the preset output data SDD and the customized output data SDC. The preset output data SDD may be data sampled based on a preset time length TLD. The preset time length TLD is stored into the memory circuit 210.

The state machine 250 may control the transmission circuit 240 to receive the first data SD1 according to a setting command CMD corresponding to sampling the first data SD1. The state machine 250 may control the transmission circuit 240 to receive the second data SD2 according to the setting command CMD corresponding to sampling the second data SD2.

The state machine 250 indicates the operation circuit 220 to generate one of the preset output data SDD and the customized output data SDC according to the setting command CMD. In this embodiment, the external component ED2 is operated to provide a setting instruction INS. The memory circuit 210 provides the setting command CMD according to the setting instruction INS. The state machine 250 indicates the operation circuit 220 to generate one of the preset output data SDD and the customized output data SDC according to the setting command CMD. The state machine 250 controls the transmission circuit 240 to output one of the preset output data SDD and the customized output data SDC according to the setting command CMD.

When indicated to generate the preset output data SDD, the timer 230 samples the second data SD2 based on the preset time length TLD. Therefore, the operation circuit 220 generates the preset output data SDD according to the plurality of voltage states of the sampled second data SD2. The operation circuit 220 may transmit the preset time length TLD stored in the memory circuit 210 to the timer 230, so as to enable the timer 230 to sample the second data SD2 according to the preset time length TLD.

When indicated to generate the customized output data SDC, the timer 230 samples the second data SD2 based on the sampling time length TLS. Therefore, the operation circuit 220 generates the customized output data SDC according to the plurality of voltage states of the sampled second data SD2. The operation circuit 220 may transmit the sampling time length TLS stored in the memory circuit 210 to the timer 230, so as to enable the timer 230 to sample the second data SD2 according to the sampling time length TLS. The implementation details of how the operation circuit 220 obtains the sampling time length TLS and generates the customized output data SDC have been clearly described in the embodiments of FIG. 1 to FIG. 4, and will therefore not be repeatedly described here.

In this embodiment, the second data SD2 may be a feedback signal related to the state of the external component ED1. The preset output data SDD and the customized output data SDC may be sampling results of the second data SD2 from the external component ED1 (such as a light-emitting component, a fan, or other controlled components). For example, the state of the external component ED1 may be at least one of operating current, operating voltage, or interrupt notification, but the disclosure is not limited thereto.

In this embodiment, the second data SD2 may be an operation command provided by the external component ED2. For example, the operation command may be at least one of operating current, operating voltage, or interrupt notification, but the disclosure is not limited thereto. The preset output data SDD and the customized output data SDC may be operation signals for controlling the external component ED1.

It should be noted that when the external components ED1 and ED2 are modified or upgraded, the sampling frequency or period may be changed. To prevent sampling errors, the internal logic of the current controller must also be modified or upgraded accordingly. In this embodiment, the controller 200 may obtain the sampling time length TLS according to the received first data SD1. When the external components ED1 and ED2 are modified or upgraded, the internal logic of the controller 200 does not need to be changed. Furthermore, the controller 200 may indicate the operation circuit 220 to generate one of the preset output data SDD and the customized output data SDC according to the setting command CMD.

In this embodiment, when the external component ED1 is a light-emitting component, the state machine 250 may also control the color of the output light of the external component ED1 according to the setting command CMD. The state machine 250 may control the transmission circuit 240 to output one of the preset output data SDD and the customized output data SDC according to the setting command CMD corresponding to the color of the output light.

In this embodiment, the transmission circuit 240 may be implemented by a transmission interface known to those skilled in the art. The state machine 250 may be implemented by a finite state machine known to those skilled in the art.

In summary of the foregoing, the operation circuit receives the first data and obtains the greatest common factor of the plurality of time lengths of the plurality of stages corresponding to the plurality of voltage states of the first data. The timer samples the second data according to the sampling time length. The operation circuit generates the customized output data according to the plurality of voltage states of the sampled second data. As a result, the controller may generate the customized output data according to the received data. When the external component is modified or upgraded, the internal logic of the controller does not need to be changed.

Although the disclosure has been described with reference to the embodiments above, the embodiments are not intended to limit the disclosure. Any person skilled in the art can make minor changes and modifications without departing from the spirit and scope of the disclosure. Therefore, the scope of the disclosure will be defined in the appended claims.

What is claimed is:

1. A controller, comprising:
a memory circuit;
an operation circuit, coupled to the memory circuit, and configured to receive first data, obtain a plurality of time lengths of a plurality of stages corresponding to a plurality of voltage states of the first data, obtain a greatest common factor of the plurality of time lengths as a sampling time length according to the plurality of time lengths, and store the sampling time length into the memory circuit; and
a timer, coupled to the operation circuit, and configured to sample second data according to the sampling time length,
wherein the operation circuit generates customized output data according to a plurality of voltage states of the sampled second data.

2. The controller according to claim 1, wherein
the plurality of voltage states of the second data comprise a high voltage state and a low voltage state,
when a first stage of the second data is in the low voltage state, a logic value corresponding to the second data in the first stage is a first logic value, and
when the first stage of the second data is in the high voltage state, the logic value corresponding to the second data in the first stage is a second logic value.

3. The controller according to claim 1, further comprising:
a transmission circuit, coupled to the operation circuit, and configured to receive the first data.

4. The controller according to claim 1, further comprising:
a state machine, coupled to the operation circuit, and configured to indicate the operation circuit to generate one of preset output data and the customized output data.

5. The controller according to claim 4, wherein the state machine indicates the operation circuit to generate one of the preset output data and the customized output data according to a setting command.

6. The controller according to claim 4, wherein when indicated to generate the preset output data, the timer samples the second data based on a preset time length, so as to enable the operation circuit to generate the preset output data according to the plurality of voltage states of the sampled second data.

7. The controller according to claim 4, wherein when indicated to generate the customized output data, the timer samples the second data based on the sampling time length, so as to enable the operation circuit to generate the customized output data according to the plurality of voltage states of the sampled second data.

8. The controller according to claim 1, wherein the memory circuit comprises:
a first memory; and
a second memory, wherein a number of bits of the first memory and a number of bits of the second memory are respectively less than a number of bits corresponding to the second data.

9. The controller according to claim 8, wherein
the operation circuit stores a first plurality of bits corresponding to the second data into the first memory,
when a storage of the first plurality of bits is completed, the operation circuit notifies the controller to read the first plurality of bits stored in the first memory, and stores a second plurality of bits corresponding to the second data into the second memory, and
when a storage of the second plurality of bits is completed, the operation circuit notifies the controller to read the second plurality of bits stored in the second memory, and clears the first plurality of bits stored in the first memory.

10. The controller according to claim 9, wherein after clearing the first plurality of bits stored in the first memory, the operation circuit stores a third plurality of bits corresponding to the second data into the first memory.

11. The controller according to claim 10, wherein the first plurality of bits, the second plurality of bits, and the third plurality of bits are combined to generate the customized output data.

12. The controller according to claim 8, wherein the number of bits corresponding to the second data is determined by the sampling time length.
